(19) United States
(12) Patent Application Publication
(10) Pub. No.: US 2025/0182928 A1
(43) Pub. Date: Jun. 5, 2025

(54) CABLE HAVING REDUCED LOSS

(71) Applicant: LS CABLE & SYSTEM LTD., Anyang-si, Gyeonggi-do (KR)

(72) Inventors: Soon Il SOHN, Uiwang-si, Gyeonggi-do (KR); Dong Eun LEE, Bucheon-si, Gyeonggi-do (KR); Kyoung Soo KIM, Bucheon-si, Gyeonggi-do (KR); Tae Hyun KIM, Seocho-gu, Seoul (KR)

(21) Appl. No.: 18/840,783

(22) PCT Filed: Apr. 5, 2022
(86) PCT No.: PCT/KR2022/095073

§ 371 Date: Aug. 22, 2024

(30) Foreign Application Priority Data
Mar. 15, 2022 (KR) 10-2022-0032193

(51) Int. Cl. H01B 7/30; H01B 1/02; H01B 7/22; H01B 9/02

(52) U.S. Cl. CPC H01B 7/30; H01B 1/02; H01B 7/228; H01B 9/027

(57) ABSTRACT

The present disclosure relates to a cable having reduced loss. Specifically, the present invention relates to a cable having reduced loss that is capable of minimizing the limitation of rated current due to heating of an outer armor and the resultant transmission loss while reducing manufacturing costs and minimizing an outer diameter and weight of the cable.

### CROSS-REFERENCE TO RELATED APPLICATIONS

The present application is a National Stage of International Application No. PCT/KR2022/095073, filed on Apr. 5, 2022, which claims priority to Korean Application No. 10-2022-0032193, filed on Mar. 15, 2022, the entire contents of each hereby incorporated by reference.

### FIELD

The present disclosure relates to a cable having reduced loss. Specifically, the present disclosure relates to a cable having reduced loss that is capable of minimizing the limitation of rated current due to heating of an outer armor and the resultant transmission loss while reducing manufacturing costs and minimizing an outer diameter and weight of the cable.

### BACKGROUND

A submarine cable is a cable that is laid at least partially on the seabed to transmit electric power between two points separated by the sea, such as continent to continent, land to island, and the like. The cable is provided with an outer armor of metal wires to protect the cable from mechanical external forces such as impact, tension, and the like that occur during shipping, laying, and line operation, specifically from damage caused by ships' anchors or fishing gear in areas with active fishing activities, and from damage caused by natural phenomena such as wind surges caused by currents or waves, friction with the seabed, and the like.

A conventional outer armor is a structural reinforcement that performs the function of enhancing the mechanical properties and performance of a cable during handling and installation, as well as providing resistance to external damage, and may be formed by cross-winding of a metal wire, which is generally made of steel, galvanized steel, copper, brass, bronze, and the like, and has a cross-sectional shape of circular, flat rectangular, and the like.

Meanwhile, in a cable with an outer armor applied by a metal wire, which is mainly a ferromagnetic material, when an alternating current (AC) flows in the conductor, there will be foucault currents, that is, eddy currents in the metal wire due to electromagnetic induction phenomena, or the rated current of the cable will be limited by temperature rise due to magnetic hysteresis loss caused by changes in magnetic flux density.

Therefore, there has been a problem that transmission loss occur due to the limitation of the rated current of the cable or the overall outer diameter and weight of the cable increase by increasing the size of the conductor in order to maintain the transmission capacity, and the manufacturing and transportation costs of the cable increase accordingly, which reduces competitiveness in terms of economy.

It may be considered to apply stainless steel (STS), which is a non-magnetic material, as the metal wire material of the armor to eliminate or minimize loss caused by the outer armor in this cable, but there is a problem that the cost is more than three times higher than that of the metal wire made of conventional steel, which reduces product competitiveness.

Therefore, there is an acute need for a cable having reduced loss that is capable of minimizing the limitation of the rated current due to heating of the outer armor and the resultant transmission loss while reducing the manufacturing costs and minimizing the outer diameter and weight of the cable.

### SUMMARY

The present disclosure is directed to providing a cable having reduced loss, which is capable of minimizing the limitation of rated current due to heating of an outer armor and the resultant transmission loss.

In addition, the present disclosure is directed to providing a cable having a reduced loss, which is capable of reducing the manufacturing cost and minimizing an outer diameter and weight of the cable.

To achieve the objects, the present disclosure is directed to providing
a cable including: an outer armor formed by cross-winding a plurality of metal wires, in which the metal wires may be made of an iron (Fe) alloy including carbon (C), silicon (Si) and manganese (Mn) as alloying elements and a balance of iron (Fe) and unavoidable impurities, the iron (Fe) alloy having a tensile strength of at least 650 MPa and a permeability of less than 200.

Here, the iron (Fe) alloy may include 0.4 wt % or more of carbon (C) relative to a total weight of the iron (Fe) alloy.

In addition, the iron (Fe) alloy may include 0.4 to 0.7 wt % of carbon (C) relative to the total weight of the iron (Fe) alloy.

Further, the iron (Fe) alloy may have a tensile strength of 650 to 850 MPa.

Further, the permeability may be 50 or more and less than 200.

Meanwhile, the iron (Fe) alloy may include 0.2 to 0.5 wt % of silicon (Si), 0.3 to 0.6 wt % of manganese (Mn), 0.05 wt % or less of phosphorus (P), and 0.05 wt % or less of sulfur (S), relative to a total weight of the iron (Fe) alloy.

In addition, the metal wire may be galvanized.

Meanwhile, the present disclosure is directed to providing a cable including: a conductor; an inner semi-conducting layer surrounding the conductor; an insulating layer surrounding the inner semi-conducting layer; an outer semi-conducting layer surrounding the insulating layer; one or more cores including a metal shielding layer surrounding the outer semi-conducting layer, and a sheath layer surrounding the metal shielding layer; a binder layer entirely surrounding the one or more cores; an outer armor surrounding the binder layer; and a jacket surrounding the outer armor.

Here, the plurality of metal wires forming the one or more cores and the outer armor may be each applied with a predetermined pitch and a predetermined direction of twist, and the twisting direction of the cores and the twisting direction of the metal wires may be identical.

In addition, the plurality of metal wires forming the one or more cores and the outer armor may be each applied with a predetermined pitch and a predetermined direction of twist, and the twisting direction of the cores and the twisting direction of the metal wires may be different.

A cable having reduced loss according to the present disclosure can minimize the limitation of rated current and the resultant transmission loss by applying a new material to a metal wire that forms an outer armor, while reducing the manufacturing costs and minimizing an outer diameter and weight of the cable.

### BRIEF DESCRIPTION OF THE DRAWINGS

FIG. 1 schematically illustrates a cross-sectional view of one embodiment of a cable according to the present disclosure.

### DETAILED DESCRIPTION

Hereinafter, exemplary embodiments of the present disclosure will be described in detail. However, the present disclosure is not limited to the exemplary embodiments to be described below and may be specified as other aspects. On the contrary, the embodiments introduced herein are provided to make the disclosed content thorough and complete, and sufficiently transfer the spirit of the present disclosure to those skilled in the art. Like reference numerals indicate like constituent elements throughout the specification.

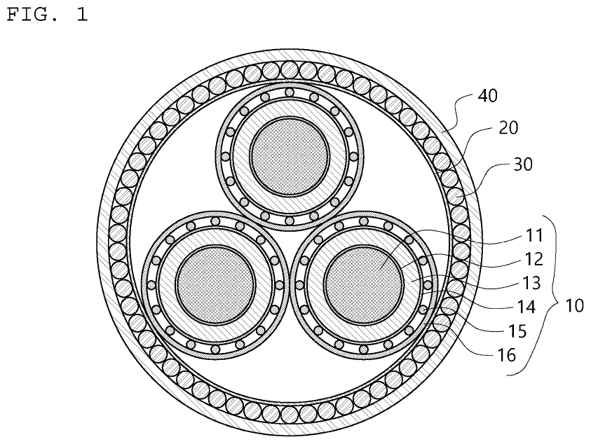

FIG. 1 schematically illustrates a cross-sectional view of one embodiment of a cable according to the present disclosure.

As illustrated in FIG. 1, a cable according to the present disclosure may include one or more conductors 11, made of high purity copper (Cu), aluminum (Al), and the like, having an excellent conductivity and having a suitable strength and flexibility, especially annealed copper wires having a large elongation and a high conductivity, to minimize power loss as a moving path of electric current for transmission, an inner semi-conducting layer 12 surrounding the conductor 11 and suppressing the uneven charge distribution on the surface of the conductor 11, easing the electric field distribution from the inside of the cable, and eliminating a gap between the conductor 11 and an insulating layer 13 described below to suppress partial discharge, insulation breakdown, and the like, the insulating layer 13 surrounding the inner semi-conducting layer 12 and made of an insulating material such as a polymer resin or insulating paper, an outer semi-conducting layer 14 surrounding the insulating layer 13 and suppressing uneven charge distribution between the insulating layer 13 and a metal shielding layer 15 described below to ease the electric field distribution, and physically protecting the insulating layer 13 from various forms of the metal shielding layer 15, the metal shielding layer 15 surrounding the outer semi-conducting layer 14 and uniformizing the electric field inside the insulating layer 13 and preventing the electric field from leaving the cable to achieve an electrostatic shielding effect, and in addition, acting as a returning path of a fault current in the event of a ground fault or short circuit accident of the cable through grounding at an end of the cable, thereby promoting safety and protecting the cable from external shocks, pressures, and the like, as well as improving the water resistance, flame retardancy, and the like of the cable, and one or more cores 10 including a sheath layer 16 surrounding the metal shielding layer 15, and the like, and may include a binder layer 20 entirely surrounding the one or more cores 10, an outer armor 20 surrounding the binder layer 20, a jacket 30 surrounding the outer armor 20, and the like, and various designs are possible depending on a cable design.

Here, the outer armor 20 may be formed by cross-winding a plurality of metal wires having a cross-sectional shape of circular or flat rectangular and made of metal and having a diameter of about 3 to 18 mm, in particular the metal wires may be made of iron (Fe) alloy or galvanized iron (Fe) alloy with zinc plated on the surface of the metal wires for corrosion protection.

In addition, the iron (Fe) alloy may include alloying elements such as carbon (C), silicon (Si), manganese (Mn), phosphorus (P), and sulfur(S), with a balance made of iron (Fe) and unavoidable impurities. The iron (Fe) alloy with such an iron (Fe) alloy applied may have a tensile strength of 650 MPa or more, preferably 650 to 850 MPa, and a permeability of less than 200, preferably 50 or more but less than 200. Here, the tensile strength may be calculated by applying a tensile load to an alloy specimen with one end of the alloy specimen connected to a fixed grip of a tester and the other end to a moving crosshead or actuator, measuring a maximum tensile load just prior to fracture, and dividing the maximum tensile load by a circular cross-sectional area of a parallel portion of the specimen.

Specifically, the carbon (C) performs a function of forming an austenite region that improves the strength of the iron (Fe) alloy while reducing magnetism within the alloy, and may be included at a content of 0.4 wt % or more, preferably 0.4 to 0.7 wt %, relative to a total weight of the iron (Fe) alloy. Here, when the content of the carbon (C) is less than 0.4 wt %, the austenite region formed inside the alloy is insufficient, resulting in insufficient reduction of permeability and magnetism. As a result the heat loss or magnetic hysteresis loss due to eddy currents may occur, which may cause the limitation of the rated current of the cable and the resultant transmission loss, or an increase in the outer diameter and weight of the cable, whereas when the content of the iron (Fe) alloy exceeds 0.7 wt %, the strength of the iron (Fe) alloy is excessive, which may lead to a decrease in workability.

In addition, the silicon (Si) performs a function of increasing the flowability of molten metal during casting of iron (Fe) alloys and acts as a nucleus of precipitates during precipitation hardening, thereby suppressing the grain diameter growth of iron (Fe) alloys at high temperatures, thus reducing the strength degradation caused by grain growth. For example, the content of the silicon (Si) may be 0.2 to 0.5 wt % relative to the total weight of the iron (Fe) alloy. When the content of the silicon (Si) is below the reference, the strength of the iron (Fe) alloy may be reduced, whereas when the content of the silicon (Si) is above the reference, the workability of the iron (Fe) alloy is degraded.

Further, the manganese (Mn) performs a function of further improving the strength of the iron (Fe) alloy and increasing the depth of hardening upon quenching treatment. For example, the content of the manganese (Mn) may be 0.3 to 0.6 wt % relative to the total weight of the iron (Fe) alloy, and when the content of the manganese (Mn) is below the reference, the strength of the iron (Fe) alloy may be insufficient, whereas when the content of the manganese (Mn) is above the reference, the acid resistance of the iron (Fe) alloy may be reduced and cracks or deformation may be induced upon quenching.

Further, phosphorus (P) and sulfur(S) are in effect already present as impurities, rather than being added and used, and may further enhance the strength of the iron (Fe) alloy and improve the workability of the iron (Fe) alloy in particular. For example, the content of the phosphorus (P) may be 0.05 wt % or less, and the content of the sulfur(S) may be 0.05 wt % or less, relative to the total weight of the iron (Fe) alloy.

Here, when the content of the phosphorus (P) exceeds the reference, a cracking phenomenon may be caused at room temperature due to the cold shortness of phosphorus (P), and when the content of the sulfur (S) exceeds the reference, a cracking phenomenon may be caused at high temperature due to the red shortness of sulfur (S).

The tensile strength of 650 MPa or more in the iron (Fe) alloy may be achieved by quenching the molten melt of the alloy in its molten state during the fabrication of the alloy, and such quenching results in an increase in the low magnetic austenite region and a decrease in the high magnetic ferrite region inside the fabricated iron (Fe) alloy, resulting in a decrease in the overall magnetism, which in turn results in a permeability of less than 200.

Here, when the tensile strength of the iron (Fe) alloy is less than 650 MPa or the permeability of the alloy is more than 200 M/m, the heat loss or magnetic hysteresis loss caused by eddy currents in electromagnetically induced phenomena cannot be sufficiently reduced due to insufficient low magnetic austenite regions inside. In contrast, when the tensile strength of the iron (Fe) alloy is greater than 850 MPa or the permeability of the alloy is less than 50, the flexibility and workability of the metal wire may be degraded and the manufacturing costs may unnecessarily increase.

When the outer armor of the cable is formed from the metal wire made of the iron (Fe) alloy possessing such reduced permeability and magnetism, the heat loss or magnetic hysteresis loss caused by eddy currents in electromagnetically induced phenomena when an alternating current (AC) flows in the conductor may be reduced by 50% or more. As a result, the limitation of the rated current of the cable and the resultant transmission loss may be minimized, while the manufacturing costs are significantly reduced compared to when the stainless steel, which is a non-magnetic body, is applied. In addition, the outer diameter and weight of the cable may be minimized by minimizing the increase in the size or weight of the conductor.

In the cable having reduced loss according to the present disclosure, the plurality of cores 10 may be applied with a predetermined pitch and predetermined direction of twist, and the plurality of metal wires forming the outer armor 30 may also be applied with a predetermined pitch and predetermined direction of twist, and the predetermined direction of twist of the cores 10 and the predetermined direction of twist of the metal wires may be the same or different.

Specifically, when the twisting direction of the cores 10 and the twisting direction of the metal wires forming the outer armor 30 are the same, the heat loss or magnetic hysteresis loss due to eddy currents in the electromagnetic induction phenomenon may be further reduced, and the workability may be improved, but it may be disadvantageous from the point of view of securing the overall tensile strength of the cable. In contrast, when the twisting direction of the cores 10 and the twisting direction of the metal wires forming the outer armor 30 are different, it is advantageous from the point of view of securing the overall tensile strength of the cable, but there is a problem that the heat loss or magnetic hysteresis loss caused by eddy currents in the electromagnetic induction phenomenon increases and the workability decreases. Therefore, an appropriate selection may be made according to the use of the cable, the laying conditions, and the like.

### EXAMPLES

### 1. Manufacturing Example

Cable specimens were manufactured in which an outer armor was formed by metal wires made of the iron (Fe) alloy listed in Table 1 below.

TABLE 1

| | Tensile | | Alloy Element Content (wt %) | | | | |
|---|---|---|---|---|---|---|---|
| | Strength | | Carbon | Silicon | Manganese | Phosphorus | Sulfur |
| | (MPa) | Permeability | (C) | (Si) | (Mn) | (P) | (S) |
| Comparative | 340 to 540 | 200 to 800 | 0.04 to 0.06 | 0.2~0.5 | 0.3 to 0.6 | ~0.05 | ~0.05 |
| Example | | | | | | | |
| Example | 650 to 850 | 50 or more | 0.4≤ | 0.2 to 0.5 | 0.3 to 0.6 | ~0.05 | ~0.05 |
| | | and less than | | | | | |
| | | 200 | | | | | |

### 2. Evaluation of Properties

### 1) Evaluation of Heat 1088

On the basis of the power transmission amount during power transmission at the rated current of the cable calculated on the premise that there is no generation of eddy currents or heating of the outer armor due to magnetic hysteresis loss when an alternating voltage is applied in the cable, the rated current of the cable is calculated in consideration of the heating of the outer armor when the same alternating voltage is applied to each cable specimen of the comparative example and the example, and the loss that corresponds to a difference in the power transmission amount during power transmission at the corresponding rated current is calculated, and the results are shown in Table 2 below.

TABLE 2

| | | Comparative | |
|---|---|---|---|
| | | Example | Example |
| Loss | Entire cable | 67 | 60 |
| (W/m) | Outer armor | 6 | 3 |

As shown in Table 2, it was confirmed that the cable according to the present disclosure minimizes heat loss due to heating of the outer armor by generation of eddy currents or magnetic hysteresis loss by applying a material having a controlled tensile strength and permeability as a material for the metal wires forming the outer armor, while the cable of the comparative example has about twice the heat loss in the outer armor and about 10% of the heat loss in the entire cable compared to the cable of the example.

### 2) Evaluation of Outer Diameter and Weight of Cable

The outer diameters and weights of cables designed with the same rated current were calculated and the results are shown in Table 3 below.

TABLE 3

| | | | Rated | Allowable | Outer | |
|---|---|---|---|---|---|---|
| | | | Current | Current | Diameter | Weight |
| | | Conductor | (A) | (A) | (mm) | (kg/m) |
| Comparative | | Cu 630SQ | 650 | 679 | 166 | 45 |
| Example | | | | | | |
| Example | 1 | Cu 630SQ | 650 | 712 | 166 | 45 |
| | 2 | Cu 500SQ | 650 | 660 | 157 | 41 |

As shown in Table 3, it was confirmed that the cable of Example 1 has an improved allowable current due to reduced heat loss due to the generation of eddy currents or heating of the outer armor by the magnetic hysteresis loss when having the same rated current compared to the cable of the comparative example of the same size. It was confirmed that the cable of Example 2 has reduced heat loss due to heating of the outer armor by the generation of eddy currents or magnetic hysteresis loss, resulting in a decrease in the overall outer diameter of the cable of about 5% and a decrease in weight of about 9% compared to the cable of the comparative example, despite having the same rated current.

While the present disclosure has been described above with reference to the exemplary embodiments, it may be understood by those skilled in the art that the present disclosure may be variously modified and changed without departing from the spirit and scope of the present disclosure disclosed in the claims. Therefore, it should be understood that any modified embodiment that essentially includes the constituent elements of the claims of the present disclosure is included in the technical scope of the present disclosure.

1. A cable comprising:
an outer armor formed by cross-winding a plurality of metal wires,
wherein the metal wires are made of an iron (Fe) alloy including carbon (C), silicon (Si) and manganese (Mn) as alloying elements and a balance of iron (Fe) and unavoidable impurities, the iron (Fe) alloy having a tensile strength of at least 650 MPa and a permeability of less than 200.

2. The cable of claim 1, wherein the iron (Fe) alloy includes 0.4 wt % or more of carbon (C) relative to a total weight of the iron (Fe) alloy.

3. The cable of claim 2, wherein the iron (Fe) alloy includes 0.4 to 0.7 wt % of carbon (C) relative to the total weight of the iron (Fe) alloy.

4. The cable of claim 2, wherein the iron (Fe) alloy has a tensile strength of 650 to 850 MPa.

5. The cable of claim 4, wherein the permeability is 50 or more and less than 200.

6. The cable of claim 1, wherein the iron (Fe) alloy includes

0. 2 to 0.5 wt % of silicon (Si), 0.3 to 0.6 wt % of manganese (Mn), 0.05 wt % or less of phosphorus (P), and 0.05 wt % or less of sulfur(S), relative to a total weight of the iron (Fe) alloy.

7. The cable of claim 1, wherein the metal wire is galvanized.

8. The cable of claim 1, comprising:
a conductor;
an inner semi-conducting layer surrounding the conductor;
an insulating layer surrounding the inner semi-conducting layer;
an outer semi-conducting layer surrounding the insulating layer;
one or more cores including a metal shielding layer surrounding the outer semi-conducting layer and a sheath layer surrounding the metal shielding layer;
a binder layer entirely surrounding the one or more cores;
an outer armor surrounding the binder layer; and
a jacket surrounding the outer armor.

9. The cable of claim 8, wherein the plurality of metal wires forming the one or more cores and the outer armor are each applied with a predetermined pitch and a predetermined direction of twist, and
wherein the twisting direction of the cores and the twisting direction of the metal wires are identical.

10. The cable of claim 8, wherein the plurality of metal wires forming the one or more cores and the outer armor are each applied with a predetermined pitch and a predetermined direction of twist, and
wherein the twisting direction of the cores and the twisting direction of the metal wires are different.
